(19) United States
(12) Patent Application Publication
(10) Pub. No.: US 2019/0315106 A1
(43) Pub. Date: Oct. 17, 2019

(54) MULTILAYER OXYGEN BARRIER FILM WITH IMPROVED HOT WATER RESISTANCE

(71) Applicants: SRtechnopack Co., Ltd., Chungcheongnam-do (KR); SRchemical Co., Ltd., Gyeonggi-do (KR)

(72) Inventors: Hong-ro Cho, Seoul (KR); Dong-hyun Sung, Incheon (KR); Dae-hoon Cho, Busan (KR)

(73) Assignees: SRtechnopack Co., Ltd., Chungcheongnam-do (KR); SRchemical Co., Ltd., Gyeonggi-do (KR)

(21) Appl. No.: 16/374,705

(22) Filed: Apr. 3, 2019

(30) Foreign Application Priority Data
Apr. 12, 2018 (KR) 10-2018-0042851

(51) Int. Cl. B32B 27/30; B32B 27/08; B32B 7/12; B32B 27/36

(52) U.S. Cl. CPC B32B 27/306; B32B 27/08; B32B 7/12; B32B 27/36; B32B 2307/308; B32B 2250/24; B32B 2307/7244; B32B 2439/70; B32B 2250/02

(57) ABSTRACT

Disclosed is a multilayer oxygen barrier film with improved hot water resistance that includes a substrate film layer 100, an oxygen barrier layer 300, and an adhesive layer 200 formed between the substrate film layer and the oxygen barrier layer, where the oxygen barrier layer 300 includes polyvinyl alcohol (PVOH) and silane, the silane having at least one epoxy group. The multilayer oxygen barrier film is very ecofriendly and capable of maintaining good oxygen barrier when in contact with hot water for long time.

### BACKGROUND

The present invention relates to a multilayer oxygen barrier film with improved hot water resistance, and more particularly to a multilayer oxygen barrier film with improved hot water resistance that maintains good oxygen barrier when in contact with hot water for long time.

Oxygen barrier is becoming an important challenge facing a variety of industries including food packaging, and a variety of oxygen barrier films have been developed in association with the oxygen barrier.

The conventional oxygen barrier films are produced using the polyvinyl-di-chloride (PVDC) lamination method. Yet, the PVDC contains chloride that is a substance restricted under the control of environment regulations, and incineration of PVDC results in dioxin emission. For these reasons, there is an urgent demand for the replacement of PVDC with an ecofriendly material.

The lamination technique based on the inorganic oxide deposition method is also used for those materials with good oxygen barrier. But, it has problems in association with extremely low production yield, a resultant rise of production cost, and the considerably low hardness of the deposition layers, which leads to a risk of cracks in the deposition layers due to shrinking and swelling with the moisture absorbed by the substrate film.

In the manufacture of an oxygen barrier film using another oxygen barrier film material, ethylene vinyl alcohol (EVOH), the EVOH film is combined with a substrate film or layered by coextrusion with the substrate film into an oxygen barrier film. Such an EVOH-based oxygen barrier film thus obtained is prone to peel due to low adhesion between the EVOH film and the substrate film. For EVOH, South Korea depends entirely on imports. Hence, a variety of studies on the alternatives to EVOH have been made actively in many domestic and international companies.

On the other hand, the polyvinyl alcohol (PVOH) material is ecofriendly and remarkably excellent in oxygen barrier properties. However, when in contact with hot water, polyvinyl alcohol of the PVOH film absorbs moisture, so the PVOH film tends to degrade in the oxygen barrier properties. This results in the limited use of the PVOH film in the food packaging applications that strongly require oxygen barrier.

In order to solve the problem with PVOH concerning the degradation of hot water resistance and oxygen barrier, many studies have been made, for example, on the method of using PVOH in combination with an inorganic substance to complement the oxygen barrier capacity of PVOH using the water resistance of the inorganic substance and the method of using PVOH in combination with polyurethane compounds to secure water repellence as well as oxygen barrier.

The cited patent document 1 discloses a method of fabricating a multilayer heat-sealable film using polyvinyl alcohol (PVOH). The film prepared by the method of the cited patent document 1 also has the unsolved problem concerning the oxygen barrier properties considerably degraded when in contact with hot water.

### PRIOR DOCUMENTATION

### Patent Document

(Patent Document 1) KR Laid-Open Publication No. 10-1993-0700176 (published on Mar. 30, 1998)

### SUMMARY

For solving the problems with the prior art, the inventors of the present invention have contrived a multi-coated oxygen barrier film with an oxygen barrier layer using polyvinyl alcohol (PVOH) in combination with a silane having at least one epoxy group to improve hot water resistance and maintain good oxygen barrier when in contact with hot water for long time.

It is an object of the present invention to provide a multilayer oxygen barrier film that maintains good oxygen barrier when in contact with hot water for long time.

In accordance with one embodiment of the present invention, there is provided a multilayer oxygen barrier film with improved hot water resistance that includes: a substrate film layer 100, an oxygen barrier layer 300, and an adhesive layer 200 formed between the substrate film layer and the oxygen barrier layer. The oxygen barrier layer 300 may include polyvinyl alcohol (PVOH) and silane, and the silane may contain at least one epoxy group.

In the multilayer oxygen barrier film with improved hot water resistance in accordance with another embodiment of the present invention, the polyvinyl alcohol (PVOH) may have a polymerization degree of 500 to 2,500 and a hydrolysis degree of 98 to 100%.

In the multilayer oxygen barrier film with improved hot water resistance in accordance with still another embodiment of the present invention, the oxygen barrier layer 300 may include 5 to 15 parts by weight of a solid portion with respect to 100 parts by weight of the oxygen barrier layer, and the solid portion may include 75 to 95 parts by weight of polyvinyl alcohol (PVOH) and 5 to 25 parts by weight of silane with respect to 100 parts by weight of the solid portion.

In the multilayer oxygen barrier film with improved hot water resistance in accordance with still another embodiment of the present invention, the adhesive layer 200 is a polyurethane primer layer. The primer constituting the polyurethane primer layer includes 5 to 15 parts by weight of a solid portion with respect to 100 parts by weight of the adhesive layer 200. The solid portion is composed of 60 to 75 parts by weight of the main component, polyester-based adhesive, and 25 to 40 parts by weight of a hardening agent.

In the multilayer oxygen barrier film with improved hot water resistance in accordance with further another embodiment of the present invention, the oxygen barrier layer 300 is 1 to 1.5 μm thick and the adhesive layer 200 is 0.5 to 1 μm thick.

The multilayer oxygen barrier film with improved hot water resistance according to the present invention includes: a substrate film layer 100 formed from polyethylene terephthalate (PET), nylon, polypropylene (PP), or polyethylene (PE) using corona treatment; an oxygen barrier layer 300; and an adhesive layer 200 formed between the substrate film layer and the oxygen barrier layer.

The oxygen barrier layer 300 includes polyvinyl alcohol (PVOH) having a polymerization degree of 1,500 and a hydrolysis degree of 98%, and (3-glycidyl oxypropyl) trimethoxysilane.

The oxygen barrier layer 300 includes 5 to 15 parts by weight of a solid portion with respect to 100 parts by weight of the oxygen barrier layer. The solid portion includes 75 to 95 parts by weight of polyvinyl alcohol (PVOH) and 5 to 25 parts by weight of (3-glycidyl oxypropyl) trimethoxysilane with respect to 100 parts by weight of the solid portion.

The multilayer oxygen barrier layer has an oxygen permeability of 0.025 to 0.04 cc/m²·day when in contact with water at 90° C. for 20 hours.

The multilayer oxygen barrier film of the present invention is very ecofriendly and able to maintain good oxygen barrier when in contact with hot water for long time.

### BRIEF DESCRIPTION OF THE DRAWINGS

FIG. 1 is a schematic cross-sectional diagram showing the laminated structure of a multilayer oxygen barrier film according to one embodiment of the present invention.

FIG. 2 is a graph showing the oxygen permeability of the multilayer oxygen barrier film according to one embodiment of the present invention.

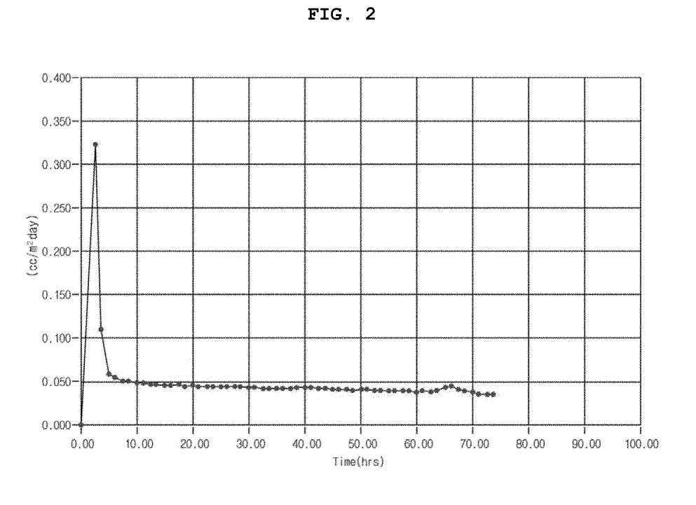

### DETAILED DESCRIPTION OF THE EMBODIMENTS

Prior to the further specific description of the present invention, it should be understood that the terms used in this disclosure and the claims are not to be confined to the common or dictionary meanings but interpreted to have meanings and concepts coinciding with the technical conceptions of the present invention on the basis of the principle that the concepts of the terms can be properly defined for the sake of the best explanation of the present invention. Therefore, specific details disclosed herein are not to be interpreted as representing all the technical conceptions of the present invention but given as a preferred example of the present invention. Obviously, many equivalents and variations that may replace the embodiments given herein are possible in the light of the teaching of the present disclosure.

Hereinafter, the present invention will be described in further detail with reference to the preferred embodiments in order for those skilled in the art to embody the present invention with ease. In the following description of the present invention, a detailed description of known functions and configurations incorporated herein will be omitted when it may make the subject matter of the present invention rather unclear.

The multilayer oxygen barrier film according to the present invention is available for various applications that may include, but are not limited to, the food packaging industry.

The multilayer oxygen barrier film of the present invention is very ecofriendly and able to maintain good oxygen barrier when in contact with hot water for long time.

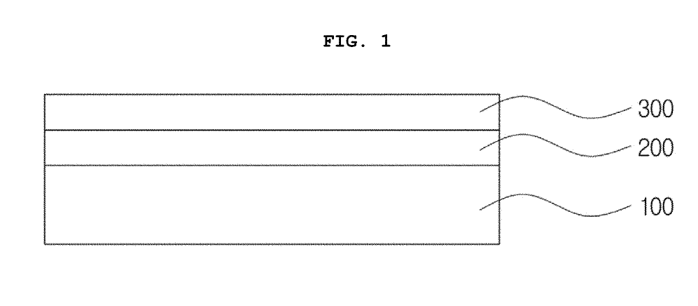

Reference will be given to FIG. 1 to describe the individual layer structures constituting the multilayer oxygen barrier film of the present invention as follows.

As schematically shown in FIG. 1, the multilayer oxygen barrier film with improved hot water resistance according to the present invention includes: a substrate film layer 100, an oxygen barrier layer 300, and an adhesive layer 200 formed between the substrate film layer and the oxygen barrier layer.

The substrate film layer 100 may be constituted with various resin films available for food packaging, such as, for example, PET, nylon, PP, PE, PLA, etc.

The substrate film layer 100 is the thickest layer in the multilayer oxygen barrier film of the present invention and used to back up the multilayer film structurally.

The substrate film layer 100 comes in different thicknesses depending on the use purpose of the multilayer film. For example, the substrate film layer 100 may have a thickness of 10 to 100 μm, preferably about 20 to 50 μm, more preferably about 30 to 40 μm.

The various resin films of PET, nylon, PP, PE, PLA, etc. used as a film forming the substrate film layer 100 may be processed by corona treatment.

Advantageously, forming the substrate film layer using a substrate film processed by corona treatment leads to the enhanced durability of the film.

On the substrate film layer 100 is formed the adhesive layer 200 that provides adhesion between the oxygen barrier layer 300 and the substrate film layer 100.

The adhesive layer 200 is a polyurethane primer layer. The primer forming the polyurethane primer layer includes 5 to 15 parts by weight of a solid portion with respect to 100 parts by weight of the adhesive layer 200.

The solid portion is comprised of a main component and a hardening agent, specifically 60 to 75 parts by weight of a polyester-based adhesive as the main component and 25 to 40 parts by weight of the hardening agent.

When the main component of the polyester-based adhesive is contained in an amount of less than 60 parts by weight with respect to 100 parts by weight of the solid portion, the primer has a reduction of the adhesiveness and a rise of the hardness. When the content of the main component is greater than 75 parts by weight with respect to 100 parts by weight of the solid portion, it may increase the adhesiveness of the primer, but tends to transfer the adhesive to the opposite side of the film while winding the film after application of the primer coating.

The hardening agent as used herein is an isocyanate-based hardening agent, preferably in an amount of 25 to 40 parts by weight with respect to 100 parts by weight of the adhesive solid portion.

When the content of the isocyanate-based hardening agent is less than 25 parts by weight with respect to 100 parts by weight of the adhesive solid portion, it may increase the adhesiveness of the primer, but tends to transfer the adhesive to the opposite side of the film while winding the film after application of the primer coating. When the isocyanate-based hardening agent is contained in an amount of greater than 40 parts by weight with respect to 100 parts by weight of the adhesive solid portion, the primer has a reduction of the adhesiveness and a rise of the hardness.

The primer coating solution for forming the adhesive layer 200 of the present invention may be prepared, for example, by the method specified as follows.

85 to 95 parts by weight of ethyl acetate is added, followed by adding 60 to 75 parts by weight of a polyester-based adhesive as a main component and 25 to 40 parts by weight of an isocyanate-based hardening agent with respect to 100 parts by weight of the adhesive solid portion and then maintaining a temperature of about 60° C. for about 6 hours under agitation to prepare a coating solution.

The oxygen barrier layer 300 may include polyvinyl alcohol (PVOH) and silane, and the silane may include at least one epoxy group.

Preferably, the silane used to prepare the multilayer film of the present invention includes at least one epoxy group. Examples of the silane as used herein may include 2-(3,4-epoxycyclohexyl) ethyltrimethoxysilane, (3-glycidoxypropyl) trimethoxysilane, 3-glycidoxypropyl methyldiethoxysilane, 2-(3,4-epoxycyclohexyl) ethyltriethoxysilane, 3-glycidoxypropylmethyl dimethoxysilane, 3-glycidoxypropyl triethoxysilane, etc.

The oxygen barrier layer 300 includes 5 to 15 parts by weight of a solid portion with respect to 100 parts by weight of the oxygen barrier layer.

The solid portion of the oxygen barrier layer 300 includes 75 to 95 parts by weight of polyvinyl alcohol (PVOH) and 5 to 25 parts by weight of silane with respect to 100 parts by weight of the solid portion.

When the polyvinyl alcohol (PVOH) is contained in an amount of less than 75 parts by weight with respect to 100 parts by weight of the solid portion of the oxygen barrier layer 300, it may increase the hot water resistance but reduce the oxygen barrier effect. When the polyvinyl alcohol (PVOH) is contained in an amount of greater than 95 parts by weight with respect to 100 parts by weight of the solid portion of the oxygen barrier layer 300, it secures good oxygen barrier in itself but reduces the hot water resistance, resulting in deterioration of the oxygen barrier due to water absorption by the multilayer film when in contact with hot water for long time.

When the content of the silane having at least one epoxy group is less than 5 parts by weight with respect to 100 parts by weight of the solid portion of the oxygen barrier layer 300, it increases the oxygen barrier effect of the coating solution, but reduces the performance of hot water resistance. When the content of the silane having at least one epoxy group is greater than 25 parts by weight with respect to 100 parts by weight of the solid portion of the oxygen barrier layer 300, it increases the hot water resistance, but reduces the oxygen barrier capacity of the coating solution.

The oxygen barrier coating solution for forming the oxygen barrier layer 300 of the present invention may be prepared, for example, by the method specified as follows.

Firstly, 75 to 95 parts by weight of polyvinyl alcohol (PVOH) is slowly added to 70 to 80 parts by weight of distilled water and dissolved by heating up to 90° C.

Then, 5 to 25 parts by weight of a silane having at least one epoxy group is added, followed by causing a reaction at the room temperature for 6 hours.

It is possible at this point to add about 1.0 part by weight of 0.1N hydrochloric acid.

The addition of 0.1N hydrochloric acid may enhance the hot water resistance of the film.

After completion of the reaction, 15 parts by weight of ethyl alcohol is added to complete an oxygen barrier coating solution.

The polyvinyl alcohol (PVOH) may have a polymerization degree of 500 to 2,500 and a hydrolysis degree of 98 to 100%.

In the multilayer oxygen barrier film with improved hot water resistance in accordance with further another embodiment of the present invention, the oxygen barrier layer 300 may include 5 to 15 parts by weight of a solid portion with respect to 100 parts by weight of the oxygen barrier layer, and the solid portion may include 75 to 95 parts by weight of polyvinyl alcohol (PVOH) and 5 to 25 parts by weight of silane with respect to 100 parts by weight of the solid portion.

In the multilayer oxygen barrier film with improved hot water resistance in accordance with further another embodiment of the present invention, the oxygen barrier layer 300 is 1 to 1.5 μm thick and the adhesive layer 200 is 0.5 to 1 μm thick.

When the PVOH oxygen barrier layer is less than 1 μm thick, it reduces the oxygen barrier properties due to the extreme thinness; and when the oxygen barrier layer is greater than 1.5 μm thick, its thickness enhances the oxygen barrier properties but causes a rise of the production cost as well as a failure to dry out after application of the coating.

When the adhesive layer 200 is less than 0.5 μm thick, it may deteriorate the adhesion between the substrate film layer 100 and the oxygen barrier layer 300, causing the layers to separate from each other. When the adhesive layer 200 is greater than 1 μm thick, it may deteriorate the flexibility of the multilayer film and cause the layers peeled off from each other due to the difference in the rate of expansion between the layers when in contact with high-temperature heat.

Hereinafter, a description will be given as to the method of preparing the multilayer film of the present invention with reference to the specified examples.

### PREPARATION EXAMPLE 1

### Preparation of PVOH Coating Solution A-1

75 g of polyvinyl alcohol (PVOH) having a polymerization degree of 1,500 and a hydrolysis degree of 98% was slowly added to 610 g of distilled water and dissolved by heating up to 90° C. 5 g of (3-glycidyloxypropyl) trimethoxysilane and 10 g of 0.1N hydrochloric acid were added to cause a reaction at the room temperature for 6 hours. Subsequently, 150 g of ethyl alcohol was added to prepare a PVOH coating solution A-1.

### PREPARATION EXAMPLE 2

### Preparation of PVOH Coating Solution A-2

65 g of polyvinyl alcohol (PVOH) having a polymerization degree of 1,500 and a hydrolysis degree of 98% was slowly added to 610 g of distilled water and dissolved by heating up to 90° C. 15 g of (3-glycidyloxypropyl) trimethoxysilane and 10 g of 0.1N hydrochloric acid were added to cause a reaction at the room temperature for 6 hours. Subsequently, 150 g of ethyl alcohol was added to prepare a PVOH coating solution A-2.

### PREPARATION EXAMPLE 3

### Preparation of PVOH Coating Solution A-3

65 g of polyvinyl alcohol (PVOH) having a polymerization degree of 1,500 and a hydrolysis degree of 98% was slowly added to 620 g of distilled water and dissolved by heating up to 90° C. 18 g of (3-glycidyloxypropyl) trimethoxysilane and 10 g of 0.1N hydrochloric acid were added to cause a reaction at the room temperature for 6 hours. Subsequently, 150 g of ethyl alcohol was added to prepare a PVOH coating solution A-3.

### PREPARATION EXAMPLE 4

### Preparation of Adhesive Coating Solution B-1

200 g of a main component of the polyester-based adhesive having 60 wt. % of the solid portion, 30 g of an isocyanate-based hardening agent having 75 wt. % of the solid portion, and 770 g of ethyl acetate were added, followed by agitating at a temperature of 60° C. for 6 hours, to prepare an adhesive coating solution B-1.

### PREPARATION EXAMPLE 5

### Preparation of Adhesive Coating Solution B-2

150 g of a main component of the polyester-based adhesive having 60 wt. % of the solid portion, 75 g of an isocyanate-based hardening agent having 75 wt. % of the solid portion, and 775 g of ethyl acetate were added, followed by agitating at a temperature of 60° C. for 6 hours, to prepare an adhesive coating solution B-2.

### PREPARATION EXAMPLE 6

### Preparation of Adhesive Coating Solution B-3

100 g of a main component of the polyester-based adhesive having 60 wt. % of the solid portion, 100 g of an isocyanate-based hardening agent having 75 wt. % of the solid portion, and 800 g of ethyl acetate were added, followed by agitating at a temperature of 60° C. for 6 hours, to prepare an adhesive coating solution B-3.

### COMPARATIVE PREPARATION EXAMPLE 1

### Preparation of PVOH Coating Solution A-4

100 g of polyvinyl alcohol (PVOH) having a polymerization degree of 1,500 and a hydrolysis degree of 98% was slowly added to 800 g of distilled water and dissolved by heating up to 90° C. Subsequently, 150 g of ethyl alcohol was added to prepare a PVOH coating solution A-4.

### COMPARATIVE PREPARATION EXAMPLE 2

### Preparation of PVOH Coating Solution A-5

150 g of polyvinyl alcohol (PVOH) having a polymerization degree of 500 and a hydrolysis degree of 98% was slowly added to 700 g of distilled water and dissolved by heating up to 90° C. Subsequently, 150 g of ethyl alcohol was added to prepare a PVOH coating solution A-5.

### EXAMPLE 1

### Adhesive Coating Solution B-1 and PVOH Coating Solution A-1

A corona-treated 36 μm-thick PET film was used as a substrate film, and the adhesive coating solution B-1 was applied on the substrate film to a dry thickness of 1 μm, followed by drying at 80° C. for one minute. Then, the PVOH coating solution A-1 was applied on the coating of the adhesive coating solution B-1 to a thickness of 1.5 μm, followed by drying at 80° C. for one minute to prepare a laminated film P-1.

### EXAMPLE 2

### Adhesive Coating Solution B-2 and PVOH Coating Solution A-1

A corona-treated 36 μm-thick PET film was used as a substrate film, and the adhesive coating solution B-2 was applied on the substrate film to a dry thickness of 1 μm, followed by drying at 80° C. for one minute. Then, the PVOH coating solution A-1 was applied on the coating of the adhesive coating solution B-2 to a thickness of 1.5 μm, followed by drying at 80° C. for one minute to prepare a laminated film P-2.

### EXAMPLE 3

### Adhesive Coating Solution B-2 and PVOH Coating Solution A-2

A corona-treated 36 μm-thick PET film was used as a substrate film, and the adhesive coating solution B-2 was applied on the substrate film to a dry thickness of 1 μm, followed by drying at 80° C. for one minute. Then, the PVOH coating solution A-2 was applied on the coating of the adhesive coating solution B-2 to a thickness of 1.5 μm, followed by drying at 80° C. for one minute to prepare a laminated film P-3.

### EXAMPLE 4

### Adhesive Coating Solution B-2 and PVOH Coating Solution A-3

A corona-treated 36 μm-thick PET film was used as a substrate film, and the adhesive coating solution B-2 was applied on the substrate film to a dry thickness of 1 μm, followed by drying at 80° C. for one minute. Then, the PVOH coating solution A-3 was applied on the coating of the adhesive coating solution B-2 to a thickness of 1.5 μm, followed by drying at 80° C. for one minute to prepare a laminated film P-4.

### EXAMPLE 5

### Adhesive Coating Solution B-3 and PVOH Coating Solution A-1

A corona-treated 36 μm-thick PET film was used as a substrate film, and the adhesive coating solution B-3 was applied on the substrate film to a dry thickness of 1 μm, followed by drying at 80° C. for one minute. Then, the PVOH coating solution A-1 was applied on the coating of the adhesive coating solution B-3 to a thickness of 1.5 μm, followed by drying at 80° C. for one minute to prepare a laminated film P-5.

### EXAMPLE 6

### Adhesive Coating Solution B-3 and PVOH Coating Solution A-2

A corona-treated 36 μm-thick PET film was used as a substrate film, and the adhesive coating solution B-3 was applied on the substrate film to a dry thickness of 1 μm, followed by drying at 80° C. for one minute. Then, the PVOH coating solution A-2 was applied on the coating of the adhesive coating solution B-3 to a thickness of 1.5 μm, followed by drying at 80° C. for one minute to prepare a laminated film P-6.

### COMPARATIVE EXAMPLE 1

### PVOH Coating Solution A-2 (Without Using Adhesive Coating Solution)

A corona-treated 36 μm-thick PET film was used as a substrate film, and the PVOH coating solution A-2 was applied on the substrate film to a thickness of 1.5 μm, followed by drying at 80° C. for one minute to prepare a laminated film P-7.

### COMPARATIVE EXAMPLE 2

### Adhesive Coating Solution B-1 and PVOH Coating Solution A-4

A corona-treated 36 μm-thick PET film was used as a substrate film, and the adhesive coating solution B-1 was applied on the substrate film to a dry thickness of 1 μm, followed by drying at 80° C. for one minute. Then, the PVOH coating solution A-4 was applied on the coating of the adhesive coating solution B-1 to a thickness of 1.5 μm, followed by drying at 80° C. for one minute to prepare a laminated film P-8.

### COMPARATIVE EXAMPLE 3

### Adhesive Coating Solution B-2 and PVOH Coating Solution A-4

A corona-treated 36 μm-thick PET film was used as a substrate film, and the adhesive coating solution B-2 was applied on the substrate film to a dry thickness of 1 μm, followed by drying at 80° C. for one minute. Then, the PVOH coating solution A-4 was applied on the coating of the adhesive coating solution B-2 to a thickness of 1.5 μm, followed by drying at 80° C. for one minute to prepare a laminated film P-9.

### COMPARATIVE EXAMPLE 4

### Adhesive Coating Solution B-2 and PVOH Coating Solution A-5

A corona-treated 36 μm-thick PET film was used as a substrate film, and the adhesive coating solution B-2 was applied on the substrate film to a dry thickness of 1 μm, followed by drying at 80° C. for one minute. Then, the PVOH coating solution A-5 was applied on the coating of the adhesive coating solution B-2 to a thickness of 1.5 μm, followed by drying at 80° C. for one minute to prepare a laminated film P-10.

The laminated films P-1 to P-10 of the Examples 1 to 6 and the Comparative Examples 1 to 4 were used to perform the following tests.

[Oxygen Permeability Test]

The oxygen permeability of the laminated films was measured according to the ASTM D 3985. The individual laminated films were cut into samples in a size of 7 cm×7 cm, and the samples were measured in regards to the oxygen permeability at 23° C. and 0% (RH) using OX-TRAN 2/21 available from MOCON. The measurement results are presented in Table 1.

[Boiling Test]

With another PET film laminated on the coated side, the individual laminated films P-1 to P-10 were cut into samples in a size of 1.5 cm×1 cm. Each sample was submerged in water at 90° C. for 30 minutes and took out of water to examine the film condition. The results are presented in Table 1.

[Peel Test]

With another PET film laminated on the coated side, the individual laminated films P-1 to P-10 were cut into samples in a size of 1.5 cm×1 cm. The laminate interface of each sample was loaded into the Universal testing machine to perform the “T” peel test. The peeling rate was 200 m/min. The test results are presented in Table 1.

TABLE 1

| | | | | Oxygen | | |
|---|---|---|---|---|---|---|
| | | | | perme- | | |
| | | Adhesive | PVOH | ability | | Peel |
| | | coating | coating | (cc/m² · | | strength |
| Div. | Film | solution | solution | day) | Boiling | (kgf/mm) |
| Example 1 | P-1 | B-1 | A-1 | 0.022 | Good | 0.0299 |
| Example 2 | P-2 | B-2 | A-1 | 0.023 | Good | 0.0325 |
| Example 3 | P-3 | B-2 | A-2 | 0.025 | Good | 0.0326 |
| Example 4 | P-4 | B-2 | A-3 | 0.037 | Good | 0.0331 |
| Example 5 | P-5 | B-3 | A-1 | 0.022 | Good | 0.0351 |
| Example 6 | P-6 | B-3 | A-2 | 0.024 | Good | 0.0352 |
| Comparative | P-7 | — | A-2 | 0.023 | Good | 0.0021 |
| Example 1 | | | | | | |
| Comparative | P-8 | B-1 | A-4 | 0.020 | Bad | 0.0305 |
| Example 2 | | | | | | |
| Comparative | P-9 | B-2 | A-4 | 0.021 | Bad | 0.0322 |
| Example 3 | | | | | | |
| Comparative | P-10 | B-2 | A-5 | 0.022 | Bad | 0.0327 |
| Example 4 | | | | | | |

Referring to Table 1, the laminated films of the Examples 1 to 6 were good in the boiling test and proved to be excellent in hot water resistance.

On the other hand, the film samples of the Examples 1 to 6 and the Comparative Examples 2, 3 and 4 were brought in contact with water at 90° C. for 1, 3, 5, 10, or 20 hours and then measured in regards to the oxygen permeability (cc/m²·day). The measurement results are presented in Table 2.

TABLE 2

| Div. | Film | 1 hr | 3 hrs | 5 hrs | 10 hrs | 20 hrs |
|---|---|---|---|---|---|---|
| Example 1 | P-1 | 0.022 | 0.023 | 0.024 | 0.025 | 0.026 |
| Example 2 | P-2 | 0.023 | 0.023 | 0.024 | 0.024 | 0.025 |
| Example 3 | P-3 | 0.025 | 0.026 | 0.026 | 0.026 | 0.027 |
| Example 4 | P-4 | 0.037 | 0.038 | 0.038 | 0.039 | 0.040 |
| Example 5 | P-5 | 0.022 | 0.022 | 0.024 | 0.024 | 0.025 |
| Example 6 | P-6 | 0.024 | 0.025 | 0.025 | 0.026 | 0.027 |
| Comparative | P-8 | 0.131 | 0.211 | 0.315 | 0.815 | 1.512 |
| Example 2 | | | | | | |
| Comparative | P-9 | 0.134 | 0.312 | 0.425 | 0.855 | 2.201 |
| Example 3 | | | | | | |
| Comparative | P-10 | 0.134 | 0.523 | 0.981 | 1.121 | 2.325 |
| Example 4 | | | | | | |

Referring to Table 2, the laminated films of the Examples 1 to 6 according to the present invention showed almost no change in the oxygen permeability after a long period of time, while those of the Comparative Examples 2, 3 and 4 had an abrupt increase in the oxygen permeability with an elapse of time. This directly underpins the fact that the multilayer films of the present invention display good hot water resistance and thus maintain the oxygen barrier capability.

What is claimed is:

1. A multilayer oxygen barrier film with improved hot water resistance, comprising:
a substrate film layer formed from polyethylene terephthalate (PET), nylon, polypropylene (PP), or polyethylene (PE) using corona treatment;
an oxygen barrier layer; and
an adhesive layer formed between the substrate film layer and the oxygen barrier layer,
the oxygen barrier layer comprising polyvinyl alcohol (PVOH) having a polymerization degree of 1,500 and a hydrolysis degree of 98% and (3-glycidyl oxypropyl) trimethoxysilane,
the oxygen barrier layer comprising 5 to 15 parts by weight of a solid portion with respect to 100 parts by weight of the oxygen barrier layer,
the solid portion of the oxygen barrier layer comprising 75 to 95 parts by weight of polyvinyl alcohol (PVOH) and 5 to 25 parts by weight of (3-glycidyl oxypropyl) trimethoxysilane with respect to 100 parts by weight of the solid portion,
the multilayer oxygen barrier layer having an oxygen permeability of 0.025 to 0.04 cc/m²·day when in contact with water at 90° C. for 20 hours.

2. The multilayer oxygen barrier film with improved hot water resistance as claimed in claim 1, wherein the oxygen barrier layer is 1 to 1.5 μm thick and the adhesive layer is 0.5 to 1 μm thick.
